(19) United States
(12) Patent Application Publication
(10) Pub. No.: US 2014/0316849 A1
(43) Pub. Date: Oct. 23, 2014

(54) METHOD AND SYSTEM FOR DETERMINING ITEM SPECIFIC USER INTEREST

(71) Applicant: KIOSKED OY, Espoo (FI)

(72) Inventors: Antti Juhani Pasila, Helsinki (FI); Lars-MichaëL Paqvalén, Espoo (FI)

(73) Assignee: KIOSKED OY, Espoo (FI)

(21) Appl. No.: 14/190,263

(22) Filed: Feb. 26, 2014

Related U.S. Application Data
(60) Provisional application No. 61/814,359, filed on Apr. 22, 2013.

(51) Int. Cl. G06Q 30/02

(52) U.S. Cl. CPC G06Q 30/0201
USPC 705/7.29

(57) ABSTRACT

A method for determining item specific user interest includes rendering a tag on top of a content item of a website, activating an e-commerce application from the tag related to the content item, and rendering a second item related to the content item on the e-commerce application. The method also includes monitoring one or more actions performed by the user related to the item on the e-commerce application. The method further includes assigning scores to the one or more actions performed by the user related to the item. In addition, the method includes determining a level of interest value of the user for the item based on scores assigned to the one or more actions.

### FIELD

The disclosure generally relates to determining item specific user interest.

### BACKGROUND

Most online targeting models either work in silos or work based on global data. When in silos, applications require users to be within the particular e-commerce applications. In this, based on the user's interaction with content provided by a particular e-commerce application, different products which the user might be interested to buy can be determined by the particular e-commerce application.

Other applications determine purchase intent by collecting data representative of the user's interests and purchase behavior such as data related to user profiles, purchase history and browsing patterns. Here, detailed statistics about a website's traffic and traffic sources can be generated. Further, conversions and sales can be measured. The collected information can be used to determine what a user would be generally interested in.

The above mentioned siloed or generic user information gathering techniques however fail to effectively determine the user's level of interest or purchase intent for a particular item. This is because a user's interest may vary based on different attributes such as brand, color, size etc. of the particular item, which is often ignored by the techniques mentioned above.

Accordingly, there is need for an improved method and system for determining product specific user interest.

### BRIEF DESCRIPTION OF THE FIGURES

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the disclosed embodiments.

FIG. 1 illustrates a block diagram of a system for determining item specific user interest in accordance with the disclosed embodiments.

FIG. 2 illustrates a flowchart of a method for determining item specific user interest in accordance with the disclosed embodiments.

FIG. 3 illustrates an example of navigating in a web page in accordance with the disclosed embodiments.

FIG. 4 shows a block diagram of a computing apparatus in accordance with the disclosed embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the disclosed embodiments.

### DETAILED DESCRIPTION

Before describing the disclosed embodiments in detail, it should be observed that the disclosed embodiments reside primarily in combinations of method steps and system components for determining item specific user interest. Accordingly, the method steps and system components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of objects does not include only those objects but may include other objects not expressly listed or inherent to such process, method, article, or apparatus. An object proceeded by “comprises . . . a” does not, without more constraints, preclude the existence of additional identical objects in the process, method, article, or apparatus that comprises the object.

The various embodiments provide a method and system for determining item specific user interest. The method includes rendering an item on an e-commerce application and monitoring one or more actions performed by the user related to the item on the e-commerce application. The method further includes assigning scores to each of the one or more actions performed by the user related to the item. In addition, the method includes determining a level of interest of the user for the item based on the scores assigned to each of the one or more actions performed by the user.

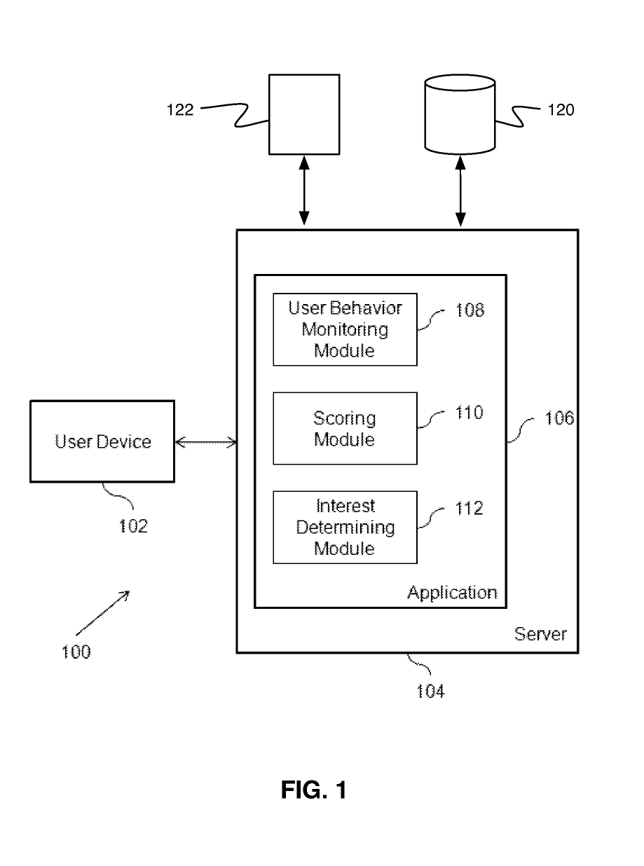

Referring to the figures and in particular FIG. 1, wherein a block diagram of a system 100 for determining item specific user interest is illustrated in accordance with the disclosed embodiments. As illustrated, system 100 includes a user device 102 and a server 104. The item can be one of, but not limited to, a product, a service, a brand and a product category.

In accordance with various embodiments, user device 102 is a device that is configured to facilitate interaction between a user and one or more applications hosted on a server such as server 104. For example, user device 102 can be one of, but not limited to, a computer, a laptop, a mobile-phone, a smart-phone, a hand-held device, a personal digital assistant (PDA) and a tablet. In accordance with the various embodiments, user device 102 is configured to facilitate the interaction between the user and the one or more applications over a network such as, but not limited to, a local area network (LAN), a metropolitan area network (MAN), a wide area network (WAN), a mobile, a wired or wireless network, a private network, or a virtual private network.

In accordance with various embodiments, server 104 is configured to host the one or more applications. For example, server 104 is configured to host an e-commerce application. Server 104 includes one or more applications such as, but not limited to, an application 106. In accordance with various embodiments, application 106 is configured to determine item specific user interest. Application 106 can be integrated with e-commerce applications such as, but not limited to, Amazon®, and e-bay®. In an embodiment, application 106 is an interactive application that can be accessed by a user to view purchasing options. For example, a virtual store, to be provided as a pop-up, can be linked to images or videos displayed on web pages. In accordance with the embodiment, application 106 can include a tag or a button provided on web content such as, but not limited to, text, image and video. The tag on the web content can be one of, but not limited to, an icon and a button. The user can activate the purchasing options by clicking on the tag. When the user clicks on the tag, the purchasing options are activated. For example, a window such as, but not limited to, a pop-up window can be displayed.

In an embodiment, application 106 includes a user behavior monitoring module 108, a scoring module 110 and an interest determining module 112. In accordance with various embodiments, user behavior monitoring module 108 is configured to monitor one or more actions performed by the user corresponding to the item. The one or more actions performed by the user which can be monitored include, but are not limited to, selecting the item, viewing details regarding the item, adding the item to a wish-list, adding the item to a shopping-cart, sharing item information on different networks such as social networks, recording the item in the wish-list, buying the item, visiting a store but not buying the item and time spent on viewing the item or item details. The one or more actions can also include, but are not limited to, activating application 106 tagged on the web content and time period for which application 106 is active.

In accordance with various embodiments, scoring module 110 is configured to score each of the one or more actions performed by the user corresponding to the item. Scoring module 110 assigns scores to each action based on a rule which can be predefined. Scoring module 110 can assign scores such as, but not limited to, points, stars or ratings to each action performed by the user. For example, 1 point can be assigned for selecting an item, 5 points can be assigned for viewing details regarding the item, 3 points can be assigned for sharing item information, etc. Scoring module 110 may also assign a ‘score to the amount of time spent on performing an action such as time spent on viewing the item or item details. For example, 1 point can be assigned if the user views the item at least for 1 minute and 5 points can be assigned if the user views the item for more than 10 minutes. Scoring module 110 also assigns scores to actions such as activating application 106 tagged on the web content and the time period for which application 106 is active. For example, if a user clicks on the tag provided on an image, 1 point can be assigned for the action of activating application 106. If the user keeps application 106 active for at least 1 minute, 1 point can be assigned and if the user keeps application 106 active for more than 10 minutes, 4 points can be assigned.

In an embodiment, scoring module 110 assigns higher scores to actions which show signs of higher interest towards the item and lower scores to the actions which show signs of lower interest towards the item. For example, 2 points can be assigned for adding the item to a wish-list and 5 points can be assigned for recording the item in the wish-list. In another example, 1 point can be assigned to the action of buying the item and 7 points can be assigned to the action of visiting a store but not buying the item. The action of selecting on option of ‘buy’ would mostly seem like the end for chances of purchasing the item again but this may not be the case always. The purchase might never actually happen in the case where the user might leave a merchant-site before finalizing the transaction. Alternatively, there may be some problems involved with shipping of the item due to which the item is not finally bought by the user. Scoring module 110 accordingly assigns higher scores until the transaction of purchasing the item is complete and until the user has actually bought the item.

In an embodiment, scoring module 110 is configured to send user data such as location and Internet Protocol (IP) address of the user; web site information such as uniform resource locator (URL); and scores of the one or more actions to one or more aggregation databases 120. The data from the databases can be utilized by interest determining module 112.

In accordance with various embodiments, interest determining module 112 is configured to determine the level of interest of the user towards the item based on the scored assigned to each action performed by the user. For example, interest determining module 112 determines how interested a user is in a particular book. Alternately, interest determining module 112 determines how interested a user is in purchasing a shirt. Likewise, interest determining module 112 can determine how interested a user is in a particular brand. The level of interest for the item determined by interest determining module 112 can be utilized to determine intent of the user for purchasing the item. Interest determining module 112 collects the scores assigned to each of the one or more actions and calculates the level of interest of the user towards the item. In one embodiment, interest determining module 112 calculates the total or average of the scores assigned to the one or more actions performed by the user. The total or the average can be used as the interest value of the user for the item. The interest value will also determine the purchase intent of the user to purchase the item.

Interest values of one or more users for one or more items can be calculated by interest determining module 112. The interest values can be sent to one or more service providers 122 such as, but not limited to, advertisers and retailers. Alternatively, the interest values of the one or more users for the one or more items can be stored in the one or more databases 120. The one or more service providers 122 can be provided access to the one or more databases 120. A threshold can be predefined for sending the interest values to the one or more service providers 122 or to the one or more databases 120. Accordingly, if an interest value is higher than the threshold, the interest value along with user data is sent to the one or more service providers 122 or to the one or more databases 120. In an embodiment, all the interest values are sent to the one or more databases 120 and the one or more service providers 122 are provided with an option to filter the list of users based on interest values for an item. The interest values can be used by the one or more service providers 122 in a wide variety of ways such as, but not limited to, for advertising, for displaying online banners, and for delivering promotions, deals and offers. Further, the advertisements associated with the item can be targeted based on a predefined threshold for the interest value. For example, if a first user has an interest value of 8 and a second user has the interest value 1 for the same product; the advertisements can be targeted to the first user.

Additionally, in order to enhance the accuracy in determining the interest value, application 106 can follow the user for a longer period of time. This can be performed by using data related to user device 102 such as, but not limited to, IP address of the user (registered user) and cookies.

In accordance with the embodiment illustrated in FIG. 1, application 106 is provided on server 104. Application 106 can be provided as a plug-in to an e-commerce application hosted by server 104. Application 106 can also be provided by a service provider as part of a service for determining item specific user interest. While application 106 can be a server based application, it is also possible to incorporate application 106 as a plug-in on user device 102 for collecting information for determining item specific user interest. For instance, functionalities of user behavior monitoring module 108, scoring module 110 and interest determining module 112 can be clubbed into the plug-in that can be installed on user device 102 for determining interest value of the user for an item.

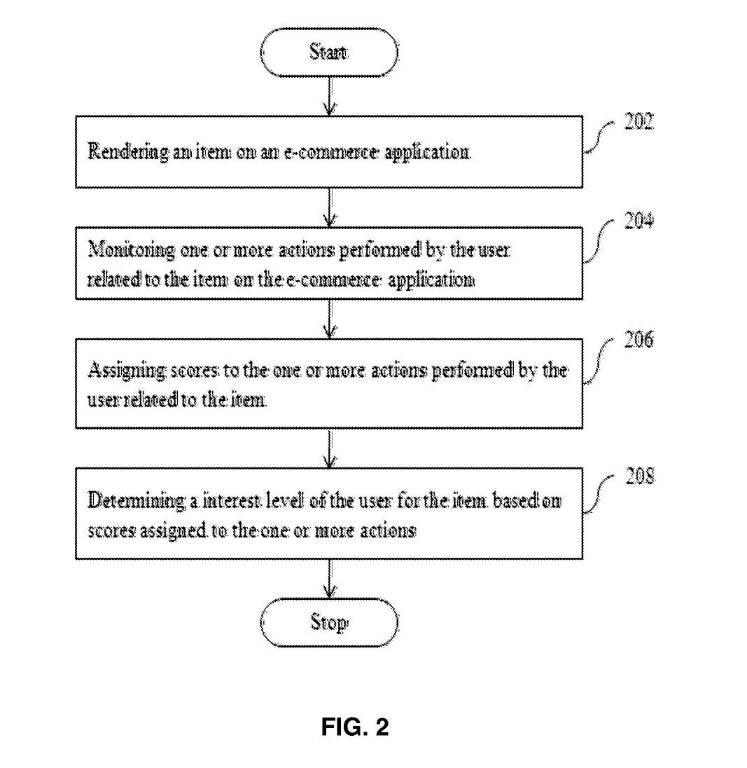

Turning now to FIG. 2, which illustrates a flowchart of a method for determining item specific user interest in accordance with the disclosed embodiments.

At step 202, an item is rendered on an e-commerce application. The e-commerce application can be one of, but not limited to, an online shopping web page, a web shop and an online shopping application. In an embodiment, the e-commerce application can be tagged on web content such as, but not limited to, text, image and video. The tag on the web content can include one of, but not limited to, an icon and a button.

At step 204, one or more actions performed by the user related to the item on the e-commerce application are monitored. The one or more actions can be, but are not limited to, selecting the item, viewing details regarding the item, adding the item to a wish-list, adding the item to a shopping-cart, sharing item information, recording the item in the wish-list, buying the item, going to a store but not buying the item and time spend on viewing the item or item details. If the e-commerce application is tagged to the web content, then the actions such as, but not limited to, activating the e-commerce application on the web content and time period for which the e-commerce application is active are also monitored.

At step 206, scores are assigned to the one or more actions performed by the user related to the item. The scores/values are assigned to the one or more actions based on a predefined rule. Scores assigned to the one or more actions can be, but are not limited to, points, values, stars or ratings. For example, 1 point can be assigned for the action of selecting the item and 5 points can be assigned for the action of viewing details regarding the item on the e-commerce application. The score can also be assigned for the amount of time spent on performing an action such as time spent on viewing the item or item details. For example, 1 point can be assigned if the user views the item at least for 1 minute and 5 points can be assigned if the user views the item for more than 10 minutes. The scores can also be assigned to the actions such as activating the e-commerce application on the web content and time period for which the e-commerce application is active. Assuming, a user is watching a video which is tagged with the e-commerce application. While watching the video, when the user performs an action of clicking on the tag to open the e-commerce application, 1 point can be assigned. If the user keeps the e-commerce application active for at least one minute, 1 point can be assigned. If the user keeps the e-commerce application open for more than 10 minutes, 5 points can be assigned. If user shares the item with others 3 points can be assigned. Points/values can have any number including negative and positive numbers or zero as well as non integer numbers.

In an embodiment, higher scores are assigned to the actions which show signs of higher interest towards the item by the user and lower scores are assigned to the actions which show signs of lower interest towards the item by the user. For example, 2 points can be assigned to the action of adding the item to a wish-list and 5 points can be assigned to the action of recording the item in the wish-list.

Thereafter, at step 208, an interest value of the user for the item is determined based on scores assigned to the one or more actions. In an embodiment, the total of all the scores assigned to the one or more actions of the user related to the item can be calculated to determine the interest value of the user for the item. In another embodiment, the average of all the scores assigned to the one or more actions can be calculated to determine the interest value of the user for the item.

In an exemplary embodiment, a user is viewing a website which includes sports images and each image includes a tag to open an e-commerce application. The user clicks on a golfer's image which indicates that the user may be interested in golf. Further, the user clicks on the tag to activate the e-commerce application. Once the e-commerce application is activated, a pop-up window opens which accordingly displays items related to golf in the pop-up window. Thereafter, the user clicks on golf shoes which may indicate that the user is interested in golf shoes. As and when the user starts interacting with the e-commerce application, points are assigned to each action performed by the user. When the user opens the e-commerce application, the following points assigning scheme can be used for assigning points to actions performed by the user:
1 point is assigned to the action (X1) of opening the e-commerce application
1 point is assigned for each minute, till maximum limit of 10 minutes, for which the user keeps the e-commerce application open
4 points are assigned to the action (X2) of keeping the e-commerce application opens for a time period of 4 minutes
5 points are assigned to action (X3) of clicking on “more info” for the gold shoes
2 points are assigned to the action (X4) of adding the golf shoes to the want-list of the user
5 points are assigned for the action (X5) of recording the golf shoes in the want list
1 point is assigned to the action (X6) of clicking on “buy” button
7 points are assigned to the action (X7) of visiting the website of the golf shoes but not buying the golf shoes
3 points are assigned to the action (X8) of clicking on “find store”
5 points are assigned to the action (X9) of viewing the results after clicking on “find store”
3 points are assigned to the action (X10) of sharing the details of golf shoes on a social media site

The interest value is calculated based on what actions the user has performed. If the user has performed the actions X1, X2, X3, X4, X5, X7 and X10, then the interest value is calculated as follows:

The interest value of the user for the golf shoes=1+4+5+2+5+7+3

Thus, based on the above score, it can be determined that the chances of the user purchasing the golf shoes are substantially high. Based on the interest value of the user for the golf shoes, the user can be targeted with advertisements related to golf shoes.

The disclosed method and system determines item specific user interest, wherein how interested a user is in a particular item such as for example level of interest in the item, level of interest in purchasing the item. The interest value of the user for the item can be distributed to service providers such as, but not limited to, advertisers and retailers. Using the data of the interest value for the item, advertisements can be targeted to the user. The interest value of the user for the item can also be collected in a database, which can be accessed by authorized third parties for targeting content such as, but not limited to, advertisements, deals, promotion, and offers to the user.

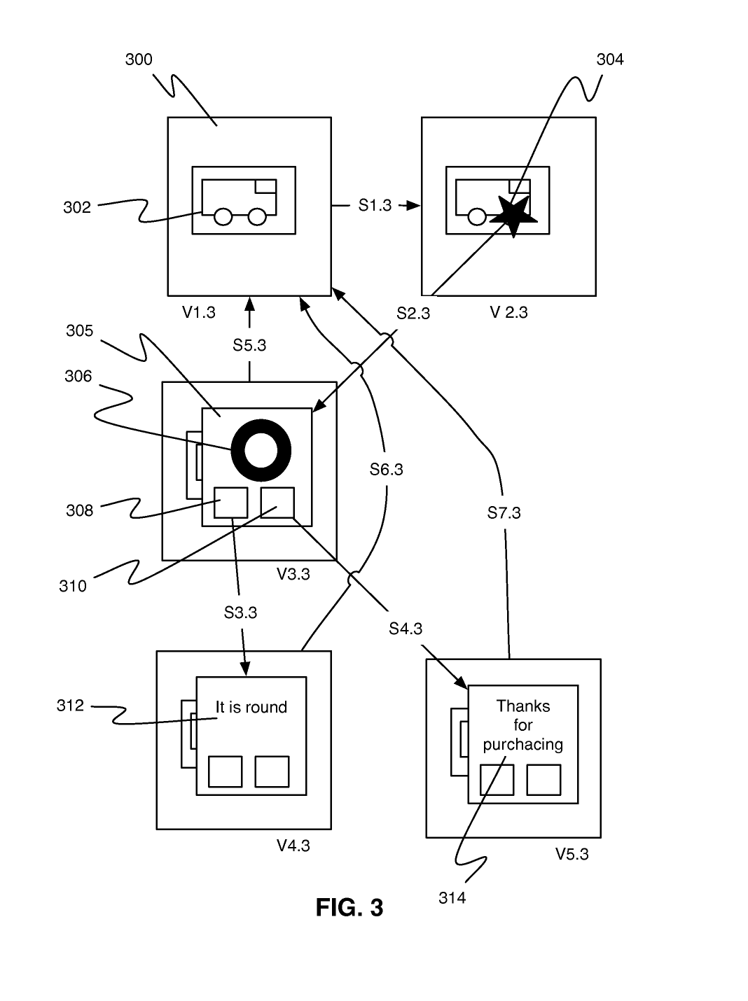

As further example FIG. 3. shows views V1.3, V2.3, V3.3, V4.3, and V5.3 of a user interface of a device used by a user. In the example web site 300 is from a publisher such as a newspaper. View V1.3 shows the website 300 which includes an image 302 of a car. In step S1.3 the user hovers over the image with a mouse (or other pointer) or selects the image for example using touch screen and a tag 304 appears on top of the image 302 (view V2.3). In step S2.3 the user selects the tag 304. An e-commerce application view 305 is rendered on top of the publisher's web site 300 (view V3.3). Based on at least one embodiment, a timer is initialized as the e-commerce application is made visible for the user. In at least one aspect of the disclosed embodiments the publisher's web site 300 and content of the site is visible under the semi transparent e-commerce application 305 or the size of the e-commerce application 305 information area is smaller than the publisher's web site 300. This enables a user to return in a convenient way back to the web site 300 view (V1.3) after visiting/exploring the e-commerce application 305 (as indicated with Step S5.3). If user elects to return to view V1.3 the timer related to the score calculator is stopped and the related time is stored in system memory.

E-commerce application view 305 can include, for example, information related to image 302 such as a picture 306 of a wheel. In addition to the picture of the wheel, there can be text and videos related to the wheel. Text can include, for example, a brand name of a wheel offered via/by the e-commerce application. The e-commerce application can have one or more user selectable items such as “More info” button 308 and “Purchase now” button 310. Based on various embodiments, selecting one or more items within the e-commerce application results in a modification of a consumer interest score. In step S3.3 the user selects the “More info” button 308 and more information (“It is round”) 312 of the wheel 306 is presented to the user in view V4.3. As the user looks at the more information field a timer for calculating a score related to interest on the more info item might be started. In step S6.3 the user clicks on an area outside of the e-commerce application and returns to web site view V1.3. The timers are stopped and the score related to selecting the “More info” button 308 is stored and recorded.

In step S4.3 user presses a “Purchase now” button 310. A score related to interest of completing the purchase is recorded. In view V5.3 user completed and related thank you text 314 is presented to the user. In step S7.3 the user returns to web site view V 1.3.

Based on further embodiments, completing the purchase might reduce or reset the score since according to certain probability a person who already has a particular product does not typically want to purchase the same product again. Based on still further embodiments the interest score is assigned to certain a product or product categories i.e. a person might have one or more scores associated with different products or product categories. According to various embodiments a score can be automatically decreased as a function of time (interest decay time). For example if a person has not visited or shown interest in a certain product or product group the score could be divided by 2 for example every 7 days. Alternatively a score can be kept the same or it can be reduced with equal increments or the score can be reduced by certain a percentage value per determined time unit. The time and decreasing function can be altered for products and products groups as well as per user. For example certain users might have a longer “half time” for score reduction than others

The determined value/score can be used by a service provider or by a web shop owner to determine which of the customers are most likely to complete the purchase. Based on various embodiments this information can be used in the decision process of providing additional advertisements or allocating further communication resources to said user. The system gives thus a technical benefit of potentially reducing the amount of communication from advertiser to users since the communication (direct advertisement or communication related to web sites) can be allocated based on interest level on the item. For example if there are 15 consumers with a determined level of interest in an item and there are resources to provide the item related communication to only 10 persons during a coming time period (such as a day) the communication resource should be directed consumers which are most interested in the item. More customized, thus more resource intensive, communication can be provided to persons which have shown the most interest including, for example, placing direct phone calls.

As an additional example, the system may collect user interest scores of Product1, Product2, and Product3 for users User1, User2, User3 and User4 as shown in Table I. Based on the collected user interest scores, the system could be configured to provide more information or to allocate more advertisement resources related to Product3 to User1 and User3, and to provide more information on Product1 to User2 based the levels of user interest. Further, the collected user interest scores can be utilized to decide which product information to provide for User4. For example, the Sum or Average of user interest scores for each of the products could be used to determine that new user User4 would be provided with product information related to Product3. In addition, the collected user interest scores could be used to determine which of the users have the most interest in general. The Sum or Average score for each user can be used to determine a general value of each user's interest level. For example User3 has a highest average interest score of the group of User1, User2 and User3.

Furthermore, the system can be used to provide different e-commerce applications to the users to determine an efficiency of the different e-commerce applications for engaging users. The different e-commerce applications can also be rated by calculating average user interests on the products offered for the users as shown in the Table I. This can be used to determine which e-commerce application and product catalog is best suited for rendering on top of a website.

TABLE I
Example user interests for products shown in an e-commerce
application rendered in top of a website.

| | User1 | User2 | User3 | User4 | Sum | Average |
|---|---|---|---|---|---|---|
| Product1 | 3 | 5 | 7 | Not | 15 | 5 |
| | | | | measured | | |
| Product2 | 8 | 3 | Not | Not | 11 | 5.5 |
| | | | measured | measured | | |
| Product3 | 9 | 3 | 12 | Not | 24 | 8 |
| | | | | measured | | |
| Sum | 20 | 16 | 19 | N/A | 50 | N/A |
| Average | 6.7 | 5.3 | 9.5 | N/A | 16.7 | 6.2 |

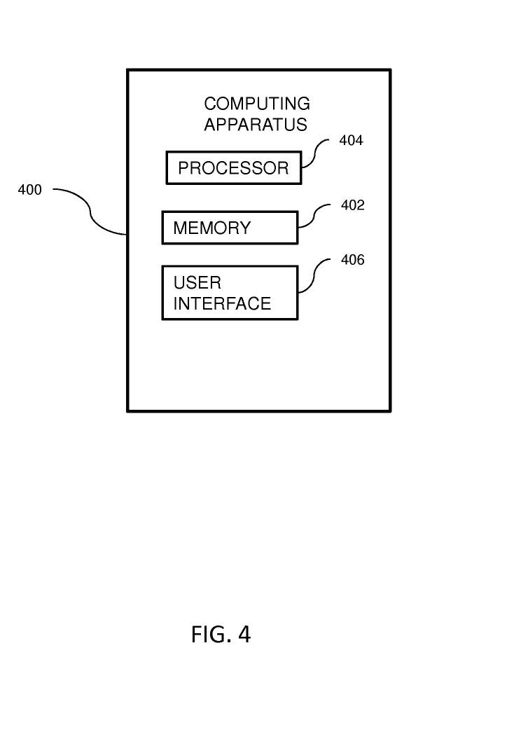

In at least one aspect of the disclosed embodiments, the systems and methods disclosed herein may be executed by one or more computers under the control of one or more programs stored on a computer readable medium. FIG. 4 shows a block diagram of a computing apparatus 400 that may be used to practice aspects of the disclosed embodiments. In at least one exemplary aspect, each of the user device 102, server 104 and other disclosed devices and systems may be implemented using an instance or replica of the computing apparatus 400 or may be combined or distributed among any number of instances or replicas of computing apparatus 400.

The computing apparatus 400 may include computer readable program code stored on at least one computer readable medium 402 for carrying out and executing the processes and methods described herein. The computer readable medium 402 may be a memory of the computing apparatus 400. In alternate aspects, the computer readable program code may be stored in a memory external to, or remote from, the apparatus 400. The memory may include magnetic media, semiconductor media, optical media, or any media which is readable and executable by a computer. Computing apparatus 400 may also include a processor 404 for executing the computer readable program code stored on the at least one computer readable medium 402. In at least one aspect, computing apparatus may include one or more input or output devices, generally referred to as a user interface 406, similar to the user interface described above, which may operate to allow input to the computing apparatus 400 or to provide output from the computing apparatus 400, respectively. The user interface may include one or more of a display, touch screen, buttons, audio input device and audio output device.

Those skilled in the art will realize that the above-recognized advantages and other advantages described herein are merely exemplary and are not meant to be a complete rendering of all of the advantages of the various embodiments disclosed herein.

In the foregoing specification, specific embodiments have been described. However, one of ordinary skill in the art appreciates that various modifications and changes can be made without departing from the scope of the disclosed embodiments. Accordingly, the specification and figures are to be regarded in an illustrative rather than a restrictive sense, and all such modifications are intended to be included within the scope of the disclosed embodiments. The benefits, advantages, solutions to problems, and any element(s) that may cause any benefit, advantage, or solution to occur or become more pronounced are not to be construed as a critical, or required.

1. An apparatus for determining item specific user interest comprising:
a processor; and
a memory comprising program code, wherein the processor under control of the program code causes the apparatus to:
render a tag on top of a content item of a website;
activate an e-commerce application from the tag related to the content item;
render a second item related to the content item within the e-commerce application;
monitor one or more user actions related to the second item;
calculate a score for each of the one or more user actions; and
determine a value of a level of user interest based on the calculated scores.

2. The apparatus of claim 1, wherein the processor under control of the program code further causes the apparatus to calculate a score based on an amount of time the one or more user actions are performed.

3. The apparatus of claim 1, wherein the processor under control of the program code further causes the apparatus to calculate a score based on an amount of time the e-commerce application is active.

4. The apparatus of claim 1, wherein the processor under control of the program code further causes the apparatus to use the determined value of the level of user interest to target content to a user.

5. The apparatus of claim 1, wherein the processor under control of the program code further causes the apparatus to provide one or more service providers with the determined value of the level of user interest for one or more users.

6. The apparatus of claim 1, wherein the processor under control of the program code further causes the apparatus to store the level of user interest value for one or more users; and providing one or more authorized parties with access to the stored values.

7. The apparatus of claim 1, wherein the processor under control of the program code further causes the apparatus to use the determined value of the level of user interest to allocate communications resources to a user.

8. A method for determining item specific user interest comprising:
rendering a tag on top of a content item of a website;
activating an e-commerce application from the tag related to the content item;
rendering a second item related to the content item within the e-commerce application;
monitoring one or more user actions related to the second item;
calculating a score for each of the one or more user actions; and
determining a value of a level of user interest based on the calculated scores.

9. The method of claim 8, further comprising calculating a score based on an amount of time the one or more user actions are performed.

10. The method of claim 8, further calculating a score based on an amount of time the e-commerce application is active.

11. The method of claim 8, further comprising using the determined value of the level of user interest to target content to a user.

12. The method of claim 8, further comprising providing one or more service providers with the determined value of the level of user interest for one or more users.

13. The method of claim 8, further comprising storing the level of user interest value for one or more users; and providing one or more authorized parties with access to the stored values.

14. The method of claim 8, further comprising using the determined value of the level of user interest to allocate communications resources to a user.

15. A system for determining item specific user interest comprising:
a display for rendering a tag in top of a content item of a website;
a processor for activating an e-commerce application from the tag related to the content item;
a display for rendering a second item related to the content item within the e-commerce application;
a user behavior monitoring module configured to monitor one or more user actions related to the second item;
a scoring module configured to calculate a score for each of the one or more user actions; and
an interest determining module configured to determine a value of a level of user interest based on the calculated scores.

16. The system of claim 15, wherein the scoring module is further configured to calculate a score based on an amount of time the one or more user actions are performed.

17. The system of claim 15, wherein the scoring module is further configured to calculate a score based on an amount of time the e-commerce application is active.

18. The system of claim 15, wherein the system is configured to use the determined value of the level of user interest to target content to a user.

19. The system of claim 15, wherein the interest determining module is further configured to provide one or more service providers with the determined value of the level of user interest for one or more users.

20. The system of claim 15, wherein the system is configured to use the determined value of the level of user interest to allocate communications resources to a user.
